(19) United States
(12) Patent Application Publication
(10) Pub. No.: US 2005/0215448 A1
(43) Pub. Date: Sep. 29, 2005

(54) Liquid acidic hard surface cleaning composition

(76) Inventors: Marc Francois Theophile Evers, Strombeek-Bever (BE); Oreste Todini, Brussels (BE); Annick Julia Oscar Mertens, Bornem (BE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/089,256

(22) Filed: Mar. 24, 2005

(30) Foreign Application Priority Data
Mar. 25, 2004 (EP) 04447074.8

(51) Int. Cl. C11D 1/00

(52) U.S. Cl. 510/238

(57) ABSTRACT

The present invention describes liquid aqueous acidic cleaning compositions suitable for removing limescale, comprising an acid system, wherein said acid system comprises formic acid and an acid forming slightly water soluble calcium salts. The compositions of the present invention deliver excellent limescale removal performance as well as outstanding greasy soap scum cleaning on hard-surfaces.

### TECHNICAL FIELD

The present invention relates to liquid compositions for cleaning hard-surfaces. More specifically, the compositions of the present invention deliver improved performance in removing limescale stains which may be found on a variety of surfaces such as bathrooms, toilets and kitchen surfaces.

### BACKGROUND OF THE INVENTION

Liquid compositions for cleaning hard-surfaces have been disclosed in the art. Much of the focus for such compositions has been on providing outstanding cleaning on a variety of soils and surfaces. Indeed, tap water contains a certain amount of solubilized ions which upon water evaporation eventually deposit as salts such as calcium carbonate on hard-surfaces which are often in contact with water, resulting in an anesthetic aspect of the surfaces. This limescale formation and deposition phenomenon is even more acute in places where water is particularly hard.

It is well-known in the art that limescale deposits can be chemically removed with acidic solutions. However, it has been discovered that compositions provided in the art, are not fully satisfactory from a consumer viewpoint especially regarding the limescale release properties achieved when the cleaning composition is applied onto the surface to be treated, left to act onto said surface without any further mechanical wiping and/or agitation action, and then removed by rinsing.

Therefore, the objective of the present invention is to provide a composition suitable for removing limescale from a hard-surface or an object which exhibits outstanding limescale cleaning performance, in particular when the cleaning composition is applied onto the hard-surface or object, left to act onto said hard-surface or object, and then removed by rinsing (i.e. under soaking conditions).

It has now been found that the above objective is met by formulating a liquid aqueous acidic composition suitable for removing limescale, comprising an acid system, wherein said acid system comprises formic acid and an acid forming slightly water soluble calcium salts.

Furthermore, the compositions according to the present invention are advantageously less complex than limescale cleaning compositions described in the art and thus substantially cheaper in their formulation while delivering outstanding limescale removal performance.

It is another advantage of the present invention to provide acidic cleaning compositions which are safe to consumers and not damaging to the treated surface, especially delicate surface such as linoleum, glass, plastic, plastified wood, metal or varnished surfaces.

Further advantages and more specific properties of the compositions of the present invention will become clear after reading the following description of the invention.

### BACKGROUND ART

U.S. Pat. No. 4,587,030 discloses an acidic cleaning composition comprising a mixture of a weak inorganic acid (e.g. phosphoric or sulfamic acid) and a weak organic acid, a surfactant system comprising a major proportion of a cationic amine oxide surfactant, and a cosolvent.

U.S. Pat. No. 6,121,219 describes an acidic cleaning composition suitable for removing carbohydrate and proteinaceous soils, the composition comprising phosphoric acid, an organic carboxylic acid, a specific solvent, a phosphonate sequestrant, and a quaternary amine composition.

U.S. Pat. No. 5,935,921 discloses a limescale cleaning composition comprising phosphoric acid, an amino trialkyl phosphonic acid, an amine oxide, a cationic surfactant and an alkanol.

### SUMMARY OF THE INVENTION

The present invention relates to a liquid aqueous acidic composition suitable for removing limescale, comprising an acid system, wherein the acid system comprises formic acid and an acid forming slightly water soluble calcium salts.

The present invention also encompasses a process of removing limescale from a hard-surface or an object, comprising the step of applying a composition as described above onto the hard-surface or object, leaving the composition on the hard-surface or object to act, optionally wiping the hard-surface or object, and then rinsing the hard-surface or object.

In a further aspect, the present invention relates to the use, in a composition suitable for removing limescale from a hard-surface or an object, of a combination of formic acid and an acid forming slightly water soluble calcium salts, to improve the limescale cleaning performance of said composition.

### DETAILED DESCRIPTION OF THE INVENTION

The liquid hard-surface cleaning composition The compositions according to the present invention are designed as hard-surfaces cleaners, preferred hard-surfaces treated therewith are those located in a bathroom or in a kitchen.

The liquid compositions according to the present invention are aqueous compositions. Therefore, they typically comprise from 70% to 99% by weight of the total composition of water, preferably from 75% to 95% and more preferably from 80% to 95%.

Acid

The compositions of the present invention are acidic. Therefore, they typically have a pH below 7, preferably from 0 to 6, more preferably from 0.1 to 5, most preferably from 0.5 to 4.5.

The compositions according to the present invention comprise an acid system, wherein the acid system comprises formic acid and an acid forming slightly water soluble calcium salts. By “slightly water soluble calcium salts”, it is meant herein any calcium salts having a water solubility of 2.5% w/w and below, in distilled water at 20° C.

In a preferred embodiment, the compositions of the present invention comprise an acid forming substantially water insoluble calcium salts, more preferably an acid forming water insoluble calcium salts. By “substantially water insoluble calcium salts”, it is meant herein any calcium salts having a water solubility of 0.5% w/w and below, in distilled water at 20° C. By “water insoluble calcium salts”, it is meant herein any calcium salts having a water solubility of 0.001% w/w and below, in distilled water at 20° C.

In the context of the present invention, the compositions comprise an acid forming calcium salts which may typically have a water solubility up to 2.5% w/w, preferably up to 0.5% w/w, more preferably up to 0.001% w/w, in distilled water at 20° C.

Typically, the acid forming slightly water soluble calcium salts to be used herein may be an inorganic acid, or an organic acid, or a mixture thereof.

Preferably, the inorganic acids for use herein have the first pK of less than 3. Suitable inorganic acids for use herein, are those selected from phosphoric acid, sulfuric acid, and mixtures thereof. In a preferred embodiment of the present invention, the acid forming-slightly water soluble calcium salts is selected to be phosphoric acid.

Preferably, the organic acids for use herein have a pKa not exceeding 5. A typical organic acid which may be used herein is oxalic acid.

Therefore, typical examples of slightly water soluble calcium salts which may be formed in the context of the present invention are calcium orthophosphate monobasic Ca(H₂PO₄)₂ (solubility of about 1.8% w/w in distilled water at 30° C.), calcium orthophosphate dibasic CaHPO₄ (solubility of about 0.0316% w/w in distilled water at 38° C.), calcium orthophosphate tribasic Ca₃(PO₄)₂ (solubility of about 0.002% w/w in distilled water at 20° C.), calcium sulfate CaSO₄ (solubility of about 0.209% w/w in distilled water at 30° C.), calcium sulfate half-hydrate CaSO₄.½H₂O (solubility of about 0.3% w/w in distilled water at 20° C.), calcium sulfate dihydrate CaSO₄.2H₂O (solubility of about 0.241% w/w in distilled water at 20° C.), and calcium oxalate CaC₂O₄ (solubility of about 0.0067% w/w in distilled water at 13° C.).

For the purpose of the present invention, it is however sufficient that at least one of the above-mentioned calcium salts be formed.

In a very preferred execution of the present invention, the acid system comprises a combination of phosphoric acid and formic acid. Phosphoric acid may be purchased from J. T. Baker, whereas formic acid is commercially available from Fluka.

The amount of acid herein may vary depending on the amount of other ingredients, however suitable amounts of acid system in the compositions of the present invention, are generally comprised between 1.1% to 25.1% by weight of the total composition, preferably 8% to 20%, and most preferably 10% to 17%.

The compositions of the present invention may comprise from 0.1% to 3% by weight of the total composition of formic acid, preferably from 0.5% to 2%, more preferably from 1% to 2%, most preferably from 1.5% to 2%.

Furthermore, the compositions of the present invention may comprise from 1% to 25% by weight of the total composition of an acid forming slightly water soluble calcium salts, or mixtures thereof, preferably from 5% to 20%, more preferably from 10% to 17%, most preferably from 10% to 15%.

It has been unexpectedly found that liquid aqueous acidic cleaning compositions comprising an acid system, wherein said acid system comprises formic acid and an acid forming slightly water soluble calcium salts, provide an improved limescale cleaning performance, as compared to the cleaning performance obtained with the same compositions but in absence of formic acid. This unexpected cleaning performance improvement is particularly outstanding under the so-called soaking conditions, i.e., when no further mechanical wiping and/or agitation action is operated.

Without wishing to be bound by theory, it is believed that formic acid participates in reducing the precipitation of slightly soluble calcium salts that could be formed as a result of the interaction between calcium carbonate-containing material and an acid-containing cleaning composition. In the case of a cleaning composition comprising an acid system wherein the slightly soluble calcium salts forming acid is phosphoric acid, it is likely that CaHPO₄ salt be formed.

It has been discovered herein that formation of CaHPO₄ or other slightly water soluble calcium salts is particularly enhanced when the cleaning composition is used in soaking conditions. Under those conditions, the above-mentioned slightly soluble calcium salts may even aggregate and form a crystalline shield around the limescale stain, and then prevent phosphoric acid to proceed with its acidic action.

It has been surprisingly found that the presence of formic acid helps in reducing the formation of CaHPO₄ salt by protonation action and by scavenging free calcium cation Ca²⁺.

A further advantage associated with the use of formic arises from its highly weight effectiveness due its low molecular weight.

However, due to environmental and/or consumer safety legislation on certain countries, the use of high amounts of formic acid, such as more than 3%, in hard-surface cleaning products would not be acceptable. Hence, the use of formic as the sole acid is not feasible as the requested high levels of formic acid needed to achieve good limescale removal performance would not be tolerated by the above-mentioned legislations.

Optional Ingredients

The compositions according to the present invention may comprise a variety of optional ingredients depending on the technical benefit aimed for and the surface treated.

Suitable optional ingredients for use herein include chelating agents, nonionic surfactants, vinylpyrrolidone homopolymer or copolymer, polysaccharide polymer, radical scavengers, perfumes, solvents, other surfactants, builders, buffers, bactericides, hydrotropes, colorants, stabilizers, bleaches, bleach activators, suds controlling agents like fatty acids, enzymes, soil suspenders, dye transfer agents, brighteners, anti dusting agents, dispersants, dye transfer inhibitors, pigments, caustic, dyes.

Chelating Agent

The compositions of the present invention may further comprise a chelating agent or mixtures thereof, as a highly preferred optional ingredient. Chelating agents can be incorporated in the compositions herein in amounts ranging from 0% to 10% by weight of the total composition, preferably 0.01% to 5.0%, more preferably 0.05% to 1%.

Suitable phosphonate chelating agents to be used herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities.

Preferred chelating agents to be used herein are diethylene triamine penta methylene phosphonate (DTPMP) and ethane 1-hydroxy diphosphonate (HEDP). In a particularly preferred execution of the present invention, the chelating agent is selected to be ethane 1-hydroxy diphosphonate (HEDP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acids is, for instance, commercially available under the tradename ssEDDS® from Palmer Research Laboratories.

Suitable amino carboxylates to be used herein include ethylene diamine tetra acetates, diethylene triamine pentaacetates, diethylene triamine pentaacetate (DTPA),N-hydroxyethylethylenediamine triacetates, nitrilotriacetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents to be used herein include salicylic acid, aspartic acid, glutamic acid, glycine, malonic acid or mixtures thereof.

It has been surprisingly found that addition of a chelating agent such as HEDP in the composition of the present invention provides an unexpected improvement in terms or limescale removal. In the context of the present invention, it has been discovered that HEDP further reduce the precipitation of slightly soluble calcium salts, by scavenging free calcium cation Ca²⁺. In that sense, HEDP and formic acid function partly in a similar way when it comes to improve limescale removal performance. As a consequence, acidic compositions with lower formic acid content may be advantageously formulated when HEDP is included into the corresponding compositions.

Without wishing to be bound by theory, it is further believed that a highly synergetic effect is achieved in terms of limescale removal performance, when a chelating agent such as those described above is combined with an acid forming slightly soluble calcium salts, in particular phosphoric acid.

Nonionic Surfactant

The compositions of the present invention may preferably comprise a nonionic surfactant, or a mixture thereof. Such class of surfactants may be desired as they further contribute to cleaning performance of the hard-surface cleaning compositions herein. It has been found in particular that nonionic surfactants strongly contribute in achieving highly improved performance on greasy soap scum removal.

The compositions according to the present invention may comprise up to 15% by weight of the total composition of a nonionic surfactant or a mixture thereof, preferably from 0.1% to 15%, more preferably from 1% to 10%, even more preferably from 1% to 5%, and most preferably from 1% to 3%.

Suitable nonionic surfactants for use herein are alkoxylated alcohol nonionic surfactants which can be readily made by condensation processes which are well-known in the art. However, a great variety of such alkoxylated alcohols, especially ethoxylated and/or propoxylated alcohols is also conveniently commercially available. Surfactants catalogs are available which list a number of surfactants, including nonionics.

Accordingly, preferred alkoxylated alcohols for use herein are nonionic surfactants according to the formula RO(E)e(P)pH where R is a hydrocarbon chain of from 2 to 24 carbon atoms, E is ethylene oxide and P is propylene oxide, and e and p which represent the average degree of, respectively ethoxylation and propoxylation, are of from 0 to 24. The hydrophobic moiety of the nonionic compound can be a primary or secondary, straight or branched alcohol having from 8 to 24 carbon atoms.

Preferred nonionic surfactants for use in the compositions according to the invention are the condensation products of ethylene oxide with alcohols having a straight alkyl chain, having from 6 to 22 carbon atoms, wherein the degree of ethoxylation is from 1 to 15, preferably from 5 to 12. Such suitable nonionic surfactants are commercially available from Shell, for instance, under the trade name Dobanol® or from BASF under the trade name Lutensol®.

Vinylpyrrolidone Homopolymer or Copolymer

The compositions of the present invention may optionally comprise a vinylpyrrolidone homopolymer or copolymer, or a mixture thereof. Typically, the compositions of the present invention may comprise from 0.01% to 5% by weight of the total composition of a vinylpyrrolidone homopolymer or copolymer, or a mixture thereof, more preferably from 0.05% to 3% and most preferably from 0.05% to 1%.

Suitable vinylpyrrolidone homopolymers for use herein are homopolymers of N-vinylpyrrolidone having the following repeating monomer: 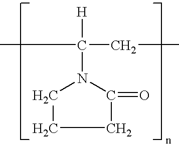
wherein n (degree of polymerisation) is an integer of from 10 to 1,000,000, preferably from 20 to 100,000, and more preferably from 20 to 10,000.

Accordingly, suitable vinylpyrrolidone homopolymers (“PVP”) for use herein have an average molecular weight of from 1,000 to 100,000,000, preferably from 2,000 to 10,000,000, more preferably from 5,000 to 1,000,000, and most preferably from 50,000 to 500,000.

Suitable vinylpyrrolidone homopolymers are commercially available from ISP Corporation, New York, N.Y. and Montreal, Canada under the product names PVP K-15® (viscosity molecular weight of 10,000), PVP K-30® (average molecular weight of 40,000), PVP K-60® (average molecular weight of 160,000), and PVP K-90® (average molecular weight of 360,000). Other suitable vinylpyrrolidone homopolymers which are commercially available from BASF Cooperation include Sokalan HP 165®, Sokalan HP 12®, Luviskol K30®, Luviskol K60®, Luviskol K80®, Luviskol K90®; vinylpyrrolidone homopolymers known to persons skilled in the detergent field (see for example EP-A-262,897 and EP-A-256,696).

Suitable copolymers of vinylpyrrolidone for use herein include copolymers of N-vinylpyrrolidone and alkylenically unsaturated monomers or mixtures thereof.

The alkylenically unsaturated monomers of the copolymers herein include unsaturated dicarboxylic acids such as maleic acid, chloromaleic acid, fumaric acid, itaconic acid, citraconic acid, phenylmaleic acid, aconitic acid, acrylic acid, N-vinylimidazole and vinyl acetate. Any of the anhydrides of the unsaturated acids may be employed, for example acrylate, methacrylate. Aromatic monomers like styrene, sulphonated styrene, alpha-methyl styrene, vinyl toluene, t-butyl styrene and similar well known monomers may be used.

For example particularly suitable N-vinylimidazole N-vinylpyrrolidone polymers for use herein have an average molecular weight range from 5,000 to 1,000,000, preferably from 5,000 to 500,000, and more preferably from 10,000 to 200,000. The average molecular weight range was determined by light scattering as described in Barth H. G. and Mays J. W. Chemical Analysis Vol 113, “Modern Methods of Polymer Characterization”.

Such copolymers of N-vinylpyrrolidone and alkylenically unsaturated monomers like PVP/vinyl acetate copolymers are commercially available under the trade name Luviskol® series from BASF.

According to a very preferred execution of the present invention, vinylpyrrolidone homopolymers are advantageously selected.

Polysaccharide Polymer

The compositions of the present invention may optionally comprise a polysaccharide polymer or a mixture thereof. Typically, the compositions of the present invention may comprise from 0.01% to 5% by weight of the total composition of a polysaccharide polymer or a mixture thereof, more preferably from 0.05% to 3% and most preferably from 0.05% to 1%.

Suitable polysaccharide polymers for use herein include substituted cellulose materials like carboxymethylcellulose, ethyl cellulose, hydroxyethyl cellulose, hydroxypropyl cellulose, hydroxymethyl cellulose, succinoglycan and naturally occurring polysaccharide polymers like xanthan gum, guar gum, locust bean gum, tragacanth gum or derivatives thereof, or mixtures thereof.

Particularly polysaccharide polymers for use herein are xanthan gum and derivatives thereof. Xanthan gum and derivatives thereof may be commercially available for instance from Kelco under the trade name Keltrol RD®, Kelzan S® or Kelzan T®. Other suitable Xanthan gum are commercially available by Rhone Poulenc under the trade name Rhodopol T® and Rhodigel X747®. Succinoglycan gum for use herein is commercially available by Rhone Poulenc under the trade name Rheozan®.

Without intended to be bound by theory, it has been shown that vinylpyrrolidone homopolymers or copolymers, preferably the vinylpyrrolidone homopolymer, and polysaccharide polymers, preferably xanthan gum or derivatives thereof, described herein, when added into an aqueous acidic composition deliver improved shine to the treated surface as well as improved next-time cleaning benefit on said surface, while delivering good first-time hard-surface cleaning performance and good limescale removal performance. Furthermore, the formation of watermarks and/or limescale deposits upon drying is reduced or even eliminated.

Moreover, the vinylpyrrolidone homopolymers or copolymers and polysaccharide polymers further provide long lasting protection against formation of watermarks and/or deposition of limescale deposits, hence, long lasting shiny surfaces.

An additional advantage related to the use of the vinylpyrrolidone homopolymers or copolymers and polysaccharide polymers, in the acidic compositions herein, is that as they adhere on hard surface making them more hydrophilic, the surfaces themselves become smoother (this can be perceived by touching said surfaces) and this contributes to convey perception of surface perfectly descaled.

Advantageously, these benefits are obtained at low levels of vinylpyrrolidone homopolymers or copolymers and polysaccharide polymers, preferably xanthan gum or derivatives thereof, described herein, thus it is yet another advantage of the present invention to provide the desired benefits at low cost.

Radical Scavenger

The compositions of the present invention may further comprise a radical scavenger or a mixture thereof.

Suitable radical scavengers for use herein include the well-known substituted mono and dihydroxy benzenes and their analogs, alkyl and aryl carboxylates and mixtures thereof. Preferred such radical scavengers for use herein include di-tert-butyl hydroxy toluene (BHT), hydroquinone, di-tert-butyl hydroquinone, mono-tert-butyl hydroquinone, tert-butyl-hydroxy anysole, benzoic acid, toluic acid, catechol, t-butyl catechol, benzylamine, 1,1,3-tris(2-methyl-4-hydroxy-5-t-butylphenyl) butane, n-propyl-gallate or mixtures thereof and highly preferred is di-tert-butyl hydroxy toluene. Such radical scavengers like N-propyl-gallate may be commercially available from Nipa Laboratories under the trade name Nipanox S1®.

Radical scavengers when used, may be typically present herein in amounts up to 10% by weight of the total composition and preferably from 0.001% to 0.5% by weight. The presence of radical scavengers may contribute to the chemical stability of the compositions of the present invention.

Perfume

Suitable perfume compounds and compositions for use herein are for example those described in EP-A-0957156 under the paragraph entitled “Perfume” in page 13.

In a highly preferred embodiment of the present invention, the compositions comprise a perfume composition advantageously selected from the group consisting of floral acetate, eucalyptol, and mixtures thereof.

The compositions herein may comprise a perfume ingredient, or mixtures thereof, in amounts up to 5.0% by weight of the total composition, preferably in amounts of 0.1% to 1.5%.

Solvent

The compositions of the present invention may further comprise a solvent or a mixture thereof, as an optional ingredient. Solvents to be used herein include all those known to those skilled in the art of hard-surfaces cleaner compositions.

Typically, the compositions of the present invention may comprise from 0.1% to 5% by weight of the total composition of a solvent or mixtures thereof, preferably from 0.5% to 5% by weight of the total composition and more preferably from 1% to 3% by weight of the total composition.

Additional Surfactant

The compositions of the present invention may comprise an additional surfactant, or mixtures thereof, on top of the nonionic surfactant already described herein. Additional surfactants may be desired herein as they further contribute to the cleaning performance and/or shine benefit of the compositions of the present invention. Surfactants to be used herein include anionic surfactants, cationic surfactants, amphoteric surfactants, zwitterionic surfactants, and mixtures thereof.

Accordingly, the compositions according to the present invention may comprise up to 15% by weight of the total composition of another surfactant or a mixture thereof, on top of the anionic surfactant already described herein, more preferably from 0.5% to 5%, even more preferably from 0.5% to 3%, and most preferably from 0.5% to 2%. Different surfactants may be used in the present invention including anionic, cationic, zwitterionic or amphoteric surfactants. It is also possible to use mixtures of such surfactants without departing from the spirit of the present invention.

Preferred surfactants for use herein are anionic and zwitterionic surfactants since they provide excellent grease soap scum cleaning ability to the compositions of the present invention.

Anionic surfactants may be included herein as they contribute to the cleaning benefits of the hard-surface cleaning compositions of the present invention. Indeed, the presence of an anionic surfactant contributes to the greasy soap scum cleaning of the compositions herein. More generally, the presence of an anionic surfactant in the liquid acidic compositions according to the present invention allows to lower the surface tension and to improve the wettability of the surfaces being treated with the liquid acidic compositions of the present invention. Furthermore, the anionic surfactant, or a mixture thereof, helps to solubilize the soils in the compositions of the present invention.

Suitable anionic surfactants for use herein are all those commonly known by those skilled in the art. Preferably, the anionic surfactants for use herein include alkyl sulphonates, alkyl aryl sulphonates, or mixtures thereof.

Particularly suitable liner alkyl sulphonates include C12-C16 paraffin sulphonate like Hostapur® SAS commercially available from Hoechst.

Other anionic surfactants useful herein include salts (including, for example, sodium, potassium, ammonium, and substituted ammonium salts such as mono-, di- and triethanolamine salts) of soap, C₈-C₂₄ olefinsulfonates, sulphonated polycarboxylic acids prepared by sulphonation of the pyrolyzed product of alkaline earth metal citrates, e.g., as described in British patent specification No. 1,082,179; alkyl ester sulfonates such as C₁₄₋₁₆ methyl ester sulfonates; acyl glycerol sulfonates, alkyl phosphates, isethionates such as the acyl isethionates, N-acyl taurates, alkyl succinamates, acyl sarcosinates, sulfates of alkylpolysaccharides such as the sulfates of alkylpolyglucoside (the nonionic nonsulfated compounds being described below), alkyl polyethoxy carboxylates such as those of the formula RO(CH₂CH₂O)ₖCH₂COO-M⁺ wherein R is a C₈-C₂₂ alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23.

Suitable zwitterionic surfactants for use herein contain both basic and acidic groups which form an inner salt giving both cationic and anionic hydrophilic groups on the same molecule at a relatively wide range of pH's. The typical cationic group is a quaternary ammonium group, although other positively charged groups like phosphonium, imidazolium and sulfonium groups can be used. The typical anionic hydrophilic groups are carboxylates and sulfonates, although other groups like sulfates, phosphonates, and the like can be used.

Some common examples of zwitterionic surfactants (i.e. betaine/sulphobetaine) are described in U.S. Pat. Nos. 2,082,275, 2,702,279 and 2,255,082, incorporated herein by reference.

Examples of particularly suitable alkyldimethyl betaines include coconut-dimethyl betaine, lauryl dimethyl betaine, decyl dimethyl betaine, 2-(N-decyl-N, N-dimethyl-ammonia)acetate, 2-(N-coco N,N-dimethylammonio) acetate, myristyl dimethyl betaine, palmityl dimethyl betaine, cetyl dimethyl betaine, stearyl dimethyl betaine. For example Coconut dimethyl betaine is commercially available from Seppic under the trade name of Amonyl 265®. Lauryl betaine is commercially available from Albright & Wilson under the trade name Empigen BB/L®.

A further example of betaine is Lauryl-immino-dipropionate commercially available from Rhone-Poulenc under the trade name Mirataine H2C-HA®.

Particularly preferred zwitterionic surfactants for use in the compositions of the present invention are the sulfobetaine surfactants as they deliver optimum soap scum cleaning benefits.

Examples of particularly suitable sulfobetaine surfactants include tallow bis(hydroxyethyl) sulphobetaine, cocoamido propyl hydroxy sulfobetaines which are commercially available from Rhone Poulenc and Witco, under the trade name of Mirataine CBS® and Rewoteric AM CAS 15® respectively.

Suitable amines for use herein are for instance C12 dimethyl amine, coconut dimethyl amine, C12-C16 dimethyl amine. Said amines may be commercially available from Hoechst under the trade name Genamin®, AKZO under the trade name Aromox® or Fina under the trade name Radiamine®.

Suitable quaternary ammonium surfactants for use herein are according to the formula R₁, R₂R₃R₄N⁺X⁻, wherein X is a counteranion such as halogen, methyl sulphate, methyl sulphonate, or hydroxide, R₁ is a saturated or unsaturated, substituted or unsubstituted, linear or branched alkyl group containing from 1 to 30 carbon atoms, preferably from 12 to 20, more preferably from 8 to 20 and R₂, R₃ and R₄ are independently hydrogen, or saturated or unsaturated, substituted or unsubstituted, linear or branched alkyl groups containing from 1 to 4 carbon atoms, preferably from 1 to 3 and more preferably methyl. In highly preferred quaternary ammonium surfactants herein R₁ is a C₁₀-C₁₈ hydrocarbon chain, most preferably C₁₂, C₁₄, or C₁₆, and R₂, R₃ and R₄ are all three methyl, and X is halogen, preferably bromide or chloride, most preferably bromide.

Amphoteric and ampholytic detergents which can be either cationic or anionic depending upon the pH of the system are represented by detergents such as dodecylbeta-alanine, N-alkyltaurines such as the one prepared by reacting dodecylamine with sodium isethionate according to the teaching of U.S. Pat. No. 2,658,072, N-higher alkylaspartic acids such as those produced according to the teaching of U.S. Pat. No. 2,438,091, and the products sold under the trade name “Miranol”, and described in U.S. Pat. No. 2,528,378, said patents being incorporated herein by reference. Additional synthetic detergents and listings of their commercial sources can be found in McCutcheon's Detergents and Emulsifiers, North American Ed. 1980, incorporated herein by reference.

Suitable amphoteric surfactants include the amine oxides. Examples of amine oxides for use herein are for instance coconut dimethyl amine oxides, C12-C16 dimethyl amine oxides. Said amine oxides may be commercially available from Hoechst, Stephan, AKZO (under the trade name Aromox®) or FINA (under the trade name Radiamox®). Other suitable amphoteric surfactants for the purpose of the invention are the phosphine or sulfoxide surfactants.

Cationic surfactants suitable for use in compositions of the present invention are those having a long-chain hydrocarbyl group. Examples of such cationic surfactants include the ammonium surfactants such as alkyldimethylammonium halogenides. Other cationic surfactants useful herein are also described in U.S. Pat. No. 4,228,044, Cambre, issued Oct. 14, 1980, incorporated herein by reference.

Dye

The liquid compositions according to the present invention may be coloured. Accordingly, they may comprise a dye or a mixture thereof. Suitable dyes for use herein are acid-stable dyes. By “acid-stable”, it is meant herein a compound which is chemically and physically stable in the acidic environment of the compositions herein.

Caustic

In order to maintain the pH of the composition herein disclosed, the composition may further comprise a caustic or a mixture thereof, as an optional ingredient. Caustic to be used herein include all those known to those skilled in the art of hard-surfaces cleaner compositions, as hydroxides of metals, ammonia, and the like. A preferred caustic is NaOH.

The Process of Removing Limescale from a Hard-Surface or an Object

The present invention also encompasses a process of removing limescale from a hard-surface or an object comprising the step of applying a composition as described above onto the hard-surface or object.

By “hard-surface”, it is meant herein any kind of surfaces typically found in houses like bathrooms, kitchens, or in car interiors or exteriors, e.g., floors, walls, tiles, windows, sinks, showers, shower plastified curtains, wash basins, WCs, dishes, fixtures and fittings and the like made of different materials like ceramic, vinyl, no-wax vinyl, linoleum, melamine, glass, any plastics, plastified wood, metal or any painted or varnished or sealed surface and the like. The term surfaces as used herein also include household appliances including, but not limited to, washing machines, automatic dryers, refrigerators, freezers, ovens, microwave ovens, dishwashers and so on. The objects herein are objects that are subjected to limescale formation thereon. Such objects may be water-taps or parts thereof, water-valves, cutlery and the like.

Although the compositions of the present invention may comprise inorganic acids such as phosphoric acid, it has been surprisingly found that a wide range of surfaces or objects including metal surfaces or objects such as aluminium, chromed steel or stainless steel, may be treated with the above-mentioned compositions without said surfaces being damaged or corroded.

The preferred process of removing limescale from a hard-surface or an object comprises the step of applying a composition according to the present invention onto said hard-surface or object, leaving said composition on said hard-surface or object to act, preferably for an effective amount of time, more preferably for a period comprised between 1 and 10 minutes, most preferably for a period comprised between 2 and 4 minutes; optionally wiping said hard-surface or object with an appropriate instrument, e.g. a sponge; and then preferably rinsing said surface with water.

Surprisingly, the process of the present invention allows achieving improved limescale removing performance without any additional mechanical wiping and/or agitation action. This particular convenience will obviously be highly appreciated by consumers as it enables substantial time saving for the user.

In another execution of the present invention is provided a process of removing limescale from an object comprising the step of immersing said object in a bath comprising a composition according to the present invention, leaving said object in said bath for the composition to act, preferably for an effective amount of time, more preferably for a period comprised between 1 and 10 minutes, most preferably for a period comprised between 2 and 4 minutes; and then preferably rinsing said object with water.

In a further aspect, the present invention relates to the use, in a composition suitable for removing limescale from a hard-surface or an object, of a combination of formic acid and an acid forming slightly water soluble calcium salts, to improve the limescale cleaning performance of said composition.

In another preferred embodiment, the present invention is directed to the use as above described, wherein the limescale cleaning performance improvement is achieved when said composition is applied onto said hard-surface or object, said composition is left on said hard-surface or object to act, and then said hard-surface or object is rinsed.

According to still another execution, the present invention relates to the use, in a composition suitable for removing limescale from a hard-surface or an object, of a combination of formic acid and an acid forming slightly water soluble calcium salts, to reduce the formation of said slightly soluble calcium salts onto said hard-surface or object.

The compositions of the present invention may be contacted to the surface or the object to be treated in its neat form or in its diluted form. Preferably, the composition is applied in its neat form.

By “diluted form”, it is meant herein that said composition is diluted by the user, typically with water. The composition is diluted prior use to a typical dilution level of 10 to 400 times its weight of water, preferably from 10 to 200 and more preferably from 10 to 100. Usual recommended dilution level is a 1.2% dilution of the composition in water.

The compositions according to the present invention are particularly suitable for treating hard-surfaces located in bathrooms or in kitchens, and preferably in bathrooms. It is however commonly known that bathroom surfaces may be soiled by the so-called “limescale-containing stains”. By “limescale-containing stains” it is meant herein any pure limescale stains, i.e., any stains composed essentially of mineral deposits, as well as other stains which contain not only mineral deposits like calcium and/or magnesium carbonate but also soap scum (e.g., calcium stearate) and other grease (e.g. body grease).

Accordingly, it has been unexpectedly found that when the compositions of the present invention further comprise a surfactant, preferably a nonionic surfactant, those compositions allow achieving outstanding cleaning performance on various limescale-containing stains comprising not only pure limescale deposits but also at least 10% by weight of the total stain of organic deposits like soap scum and grease, preferably more than 30%.

Limescale Removal Performance Test Method:

The limescale removal capacity of a composition according to the present invention may be evaluated by soaking a marble block (marble blocks are chemically speaking very similar to limescale, i.e., they are essentially made of calcium carbonate) into 20 g of this composition. The marble is weighed before and after the experiment, and the performance is expressed in grams of marble block dissolved over time. Alternatively, limescale removing performance can also be evaluated by detecting the release of CO₂.

Greasy Soap Scum Cleaning Performance Test Method:

In this test method enamel white tiles (typically 24 cm*4 cm) are covered with typical greasy soap scum soils mainly based on calcium stearate and artificial body soils commercially available (e.g. 0.3 grams with a sprayer). The soiled tiles are then dried in an oven at a temperature of 140° C. for 20 minutes and then aged overnight at room temperature (around 20° C.-25° C.). Then the soiled tiles are cleaned using 3 ml of the composition of the present invention poured directly on a Spontex® sponge. The ability of the composition to remove greasy soap scum is measured through the number of strokes needed to perfectly clean the surface. The lower the number of strokes, the higher the greasy soap scum cleaning ability of the composition.

### EXAMPLES

These following compositions were made comprising the listed ingredients in the listed proportions (weight %). The examples herein are met to exemplify the present invention but are not necessarily used to limit or otherwise define the scope of the present invention. Compositions I to VI are compositions according to the present invention, whereas composition VII is a comparative example.

| Ingredients: | | | | | | | |
|---|---|---|---|---|---|---|---|
| (% by weight) | I | II | III | IV | V | VI | VII |
| Phosphoric acid | 12 | 12 | 10 | 15 | 12 | 12 | 15 |
| Formic acid | 1.8 | 0.8 | 3 | 0.2 | 2 | 2 | — |
| HEDP | 0.1 | — | — | — | 0.1 | — | — |
| Dobanol 91-8 | 2.2 | 2.2 | 2.2 | 2.2 | — | — | 2.2 |
| Luviskol K60 ® | 0.05 | 0.05 | 0.05 | — | — | — | 0.05 |
| Kelzan T ® | 0.28 | 0.28 | 0.28 | — | — | — | 0.28 |
| Perfume⁽*⁾ | 0.25 | 0.25 | 0.25 | 0.25 | 0.25 | 0.25 | — |

| | |
|---|---|
| Waters & Minors | Up to 100 |

The pH of these examples is below 7.
Phosphoric acid is purchased from J. T. Baker.
Formic acid is supplied by Fluka.
HEDP is a chelating agent supplied by Monsanto.
Dobanol 91-8 is an ethoxylated alcohol nonionic surfactant supplied by Shell.
Kelzan T ® is a Xanthan gum supplied by Kelco.
Luviskol K60 ® is a Polyvinylpyrrolidone supplied by BASF.
Perfume⁽*⁾ typically comprises a mixture of Floral Acetate and Eucalyptol.

Compositions I to VI exhibit excellent limescale removal performance under soaking conditions, and provide outstanding cleaning performance on greasy soap scum as they comprise a nonionic surfactant.

### Comparative Data

A comparative limescale removal performance experiment was conducted according to the limescale removal performance test method as previously described, using a marble block of 40 grams soaked into 20 grams of a limescale removal composition at room temperature during 10 minutes. Performance on limescale removal of a composition according to the present invention (Example I) was evaluated against a comparative composition (Example VII), and expressed in milligrams of marble block dissolved over 10 minutes.

| Limescale Removal | | Example |
|---|---|---|
| Test | Example I | VII |
| Marble block | 33.1 | 14.5 |
| dissolved (mg) | | |

The above results clearly show the improved limescale removal performance under soaking conditions obtained with a composition according to the present invention (e.g. composition I), i.e. compositions comprising formic acid on top of an acid forming slightly soluble calcium salts, versus a comparative composition not comprising formic acid on top of an acid forming slightly soluble calcium salts.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A liquid aqueous acidic composition suitable for removing limescale comprising an acid system, wherein said acid system comprises formic acid and an acid forming slightly water soluble calcium salts.

2. The composition according to claim 1, wherein said acid forming slightly water soluble calcium salts comprises phosphoric acid.

3. The composition according to claim 1, wherein said acid system comprises from about 1.1% to about 25.1% by weight of the composition.

4. The composition according to claim 1, wherein said acid forming slightly water soluble calcium salts and said formic acid comprise from about 1% to about 25% and from about 0.1% to about 3% by weight of the composition, respectively.

5. The composition according to claim 2, wherein said phosphoric acid and said formic acid comprise from about 10% to about 15% and from about 1.5% to about 2% by weight of the composition, respectively.

6. The composition according to claim 1 further comprising a chelating agent chosen from alkali metal ethane 1-hydroxy diphosphonates, alkylene poly (alkylene phosphonate), amino aminotri (methylene phosphonic acid), nitrilo trimethylene phosphonates, ethylene diamine tetra methylene phosphonates, and diethylene triamine penta methylene phosphonates, and mixtures thereof.

7. The composition according to claim 6, wherein said chelating comprises an alkali metal ethane 1-hydroxy diphosphonates.

8. The composition according to claim 1 further comprising a nonionic surfactant.

9. The composition according to claim 8, wherein said nonionic surfactant is a condensation product of ethylene oxide with an alcohol having a straight alkyl chain comprising from about 6 to about 22 carbon atoms and wherein the degree of ethoxylation is from about 5 to about 12 or mixtures thereof.

10. The composition according to claim 1 having a pH from about 0 to about 6.

11. The composition according to claim 1 further comprising at least one member chosen from the group comprising homopolymer or copolymer of vinylpyrrolidone, polysaccharide polymer, anionic surfactant, cationic surfactant, amphoteric surfactant, zwitterionic surfactant, radical scavenger, caustic, perfume, and dye, and mixtures thereof.

12. A method of removing limescale from a hard-surface or an object comprising the step of applying a composition according to claim 1 onto said hard-surface or object, leaving said composition on said hard-surface or object to act, optionally wiping said hard-surface or object, and then rinsing said hard-surface or object.

13. The method of claim 12, wherein the step of applying said composition according to claim 1 onto said hard-surface or object comprises immersing said hard surface or said object in a bath comprising said composition.

14. The method according to claim 12, wherein said surface or object is located in a bathroom or in a kitchen.
